(19) United States
(12) Patent Application Publication
(10) Pub. No.: US 2026/0316272 A1
(43) Pub. Date: Oct. 15, 2026

(54) Climbing Inspection Robot Capable of Self-Adaptive Obstacle Crossing in Multiple Scenarios and Control Method thereof

(71) Applicant: SHANDONG UNIVERSITY, Jinan (CN)

(72) Inventors: Shuhua GAO, Jinan (CN); Jing WANG, Jinan (CN); Zhengfang WANG, Jinan (CN); Sheng GAO, Jinan (CN); Kunmeng YANG, Jinan (CN)

(21) Appl. No.: 19/433,651

(22) Filed: Dec. 26, 2025

(30) Foreign Application Priority Data
Dec. 27, 2024 (CN) 2024119500578
Dec. 27, 2024 (CN) 2024119500671
Dec. 27, 2024 (CN) 2024119500722

(51) Int. Cl. B25J 9/16; B25J 5/00; B25J 5/02; B25J 13/08

(52) U.S. Cl. CPC B25J 9/1666; B25J 5/007; B25J 5/02; B25J 9/161; B25J 9/163; B25J 9/1697; B25J 13/089

(57) ABSTRACT

A climbing inspection robot capable of self-adaptive obstacle crossing in multiple scenarios. The climbing inspection robot includes at least three moving mechanisms, and any two adjacent moving mechanisms are connected by an inter-module linkage rod. A middle-segment portion of inter-module linkage rod is provided with a multi-DOF active spherical servo joint. Each moving mechanism at least includes a control unit, a support frame, a sensing module, and a climbing mechanism. The climbing mechanism at least includes a pair of side-arm linkage rods being symmetrically arranged on two sides of support frame. A tail end of each side-arm linkage rod is connected to a dynamic magnetic adhesion wheel through a wrist joint. A self-adaptive passive wheel assembly is further disposed at bottom of the support frame, and the self-adaptive passive wheel assembly and the dynamic magnetic adhesion wheels on two sides of self-adaptive passive wheel assembly form a three-point clamping structure.

### CROSS-REFERENCE TO RELATED APPLICATIONS

The present invention claims priorities to Chinese Patent Application No. 202411950072.2, entitled “CLIMBING INSPECTION ROBOT CAPABLE OF SELF-ADAPTIVE OBSTACLE CROSSING IN MULTIPLE SCENARIOS AND CONTROL METHOD THEREOF”, filed on Dec. 27, 2024, with the China National Intellectual Property Administration (CNIPA), Chinese Patent Application No. 202411950067.1, entitled “LIGHTWEIGHT HEAVY-LOAD DYNAMIC MAGNETIC ADHESION APPARATUS OF CLIMBING ROBOT AND CONTROL METHOD THEREOF”, filed on Dec. 27, 2024, with the CNIPA, and Chinese Patent Application No. 202411950057.8, entitled “PATH PLANNING METHOD AND SYSTEM OF CLIMBING ROBOT FOR STEEL STRUCTURE ROOF, MEDIUM, AND DEVICE”, filed on Dec. 27, 2024, with the CNIPA, which are incorporated herein by reference in their entirety and constitute a part of the present invention for all purposes.

### TECHNICAL FIELD

The present invention belongs to the field of robots, and particularly relates to a climbing inspection robot capable of self-adaptive obstacle crossing in multiple scenarios and a control method thereof.

### BACKGROUND

The statement in this section merely provides background information related to the present invention and does not necessarily constitute the prior art.

High-rise steel structures typically comprise structural systems with more than six stories (or over 30 meters), primarily formed by connecting or welding shaped steel and steel plates to form components, which are then further connected and welded. High-rise steel structures often adopt steel frame structures, which are an important bearing structural system widely used in residential, office, entertainment, and other public buildings.

High-rise steel structures have characteristics of a large number of components, varying dimensions, complex connection forms, and mutual obstruction, which poses challenges for the inspection thereof. Current inspection robots are unable to meet the requirements for visual full coverage path planning and precise spatial positioning in high-rise steel structures in terms of load capability, obstacle crossing capability, and environmental adaptability.

### SUMMARY

To solve the technical problem existing in the above background, the present invention provides a climbing inspection robot capable of self-adaptive obstacle crossing in multiple scenarios and a control method thereof, which can meet the requirements for visual full coverage path planning and precise spatial positioning in high-rise steel structures.

To achieve the above objective, the present invention adopts the following technical solutions:

According to a first aspect of the present invention, a climbing inspection robot capable of self-adaptive obstacle crossing in multiple scenarios is provided.

The climbing inspection robot capable of self-adaptive obstacle crossing in multiple scenarios, including:
at least three moving mechanisms, and any two adjacent moving mechanisms are connected by an inter-module linkage rod; and a middle-segment portion of the inter-module linkage rod is provided with a multi-DOF active spherical servo joint;
each of the at least three moving mechanisms at least includes: a control unit, a support frame, a sensing module, and a climbing mechanism; and the control unit is arranged in the support frame, and both the sensing module and the climbing mechanism are communicatively connected to the control unit;
the climbing mechanism at least includes a pair of side-arm linkage rods, which are symmetrically arranged on two sides of the support frame; and a tail end of each of the side-arm linkage rods is connected to a dynamic magnetic adhesion wheel through a wrist joint;
a self-adaptive passive wheel assembly is further arranged at a central position of the bottom of the support frame, and the self-adaptive passive wheel assembly and dynamic magnetic adhesion wheels disposed at the two sides of the support frame form a three-point clamping structure; and
the sensing module at least includes an obstacle sensing element and a distance measurement element, which are used for sensing obstacle information and detecting an obstacle distance respectively, and transmitting the obstacle information and the obstacle distance to the control unit.

As an implementation, the self-adaptive passive wheel assembly includes a self-adaptive spring, a wheel carrier, a bearing, two magnetic adhesion passive wheels, and a connecting plate; one end of the self-adaptive spring is connected to the connecting plate, and the other end is connected to a top end of the wheel carrier; the connecting plate is fixed at the bottom of the support frame; and the bearing is fixed at a tail end of the wheel carrier, and the magnetic adhesion passive wheels are mounted at two ends of the bearing.

As an implementation, the dynamic magnetic adhesion wheel includes a flexible wheel face, and Halbach array electromagnets are wrapped in the flexible wheel face; coils are wound outside the Halbach array electromagnets, and the coils are connected to a power supply module; and the Halbach array electromagnets are used for generating magnetic field intensity when the coils are powered on, to enable the dynamic magnetic adhesion wheel to adhere to the steel structure.

As an implementation, an adhesion force of the dynamic magnetic adhesion wheel is determined by the magnetic field intensity, and the magnetic field intensity is controlled by an output current of the power supply module; the output current of the power supply module is controlled by dynamically adjusting a duty cycle of a PWM signal; and the duty cycle of the PWM signal is obtained through dynamic adjustment by using a fuzzy logic control algorithm according to a current adhesion force, a set target adhesion force, and an external load change.

As an implementation, formulas of dynamically adjusting the duty cycle of the PWM signal by using the fuzzy logic control algorithm are:

$$D = \frac{{\int }_{z} z \cdot {μ}_{out} ( z ) dz}{{\int }_{z} {μ}_{out} ( z ) dz} ;$$

$${μ}_{out} ( z ) = max ( {μ}_{R 1} ( z ) , {μ}_{R 2} ( z ) , … , {μ}_{Rn} ( z ) ) ;$$

$${μ}_{Ri} ( z ) = min ( {μ}_{A} ( x ) , {μ}_{B} ( y ) ) ; i = 1 , 2 , … , n ;$$

$${μ}_{A} ( x ) = \{ \begin{matrix}1 , & x \leq a \\ \frac{b - x}{b - a} , & a < x \leq b \\ 0 , & x > b\end{matrix} ;$$

$${μ}_{A} ( x ) = \{ \begin{matrix}\frac{y - c}{d - c} , & c \leq y < d \\ 1 , & y \geq d\end{matrix} ;$$

wherein, z represents a possible value range of an output variable, and μₒᵤₜ(z) represents a multi-rule fuzzy inference membership function; x and y are the adhesion force and the load change respectively; μ_{Ri}(z) represents a fuzzy inference membership function of the climbing inspection robot under an i^{th} attitude; n represents a number of attitude types of the climbing inspection robot; μ_{A}(x) and μ_{B}(y) represent membership functions of the adhesion force and the load change respectively; and a, b, c, and d are corresponding variable parameters of the climbing inspection robot under different attitudes.

As an implementation, the multi-DOF active spherical servo joint includes a flexible housing, two active joint servos, and two rigid joint connecting rods; all the active joint servos are disposed in the flexible housing, the active joint servos are in one-to-one correspondence with the rigid joint connecting rods, and the active joint servos and the rigid joint connecting rods that correspond to each other are coupled and hinged; and one end of each of the rigid joint connecting rods further extends out of the flexible housing and is connected to the inter-module linkage rod.

As an implementation, the obstacle sensing element is fixed at a set position on the support frame of each of a head moving mechanism and a tail moving mechanism of the climbing inspection robot capable of self-adaptive obstacle crossing in multiple scenarios; and the distance measurement element is mounted on each of the dynamic magnetic adhesion wheels.

According to a second aspect of the present invention, a control method of a climbing inspection robot capable of self-adaptive obstacle crossing in multiple scenarios is provided.

The control method of a climbing inspection robot capable of self-adaptive obstacle crossing in multiple scenarios, including:
determining a next to-be-executed obstacle avoidance operation according to currently sensed obstacle information and a detected obstacle distance; and
controlling an attitude of the climbing inspection robot based on a current attitude and the next to-be-executed obstacle avoidance operation of the climbing inspection robot, to enable the climbing inspection robot to avoid an obstacle successfully;
wherein, a process of the obstacle avoidance operation includes:
controlling a multi-DOF active spherical servo joint to drive an inter-module linkage rod and a head moving mechanism to move, to enable the head moving mechanism to lift, simultaneously controlling the dynamic magnetic adhesion wheels of the head moving mechanism to lift to avoid the obstacle, controlling the climbing inspection robot to move forward, to enable the head moving mechanism to cross the obstacle, and controlling a middle moving mechanism to be ready to lift;
controlling the dynamic magnetic adhesion wheel of the head moving mechanism to return to an original state to attach and adhere to a steel structure, controlling the multi-DOF active spherical servo joint to drive the inter-module linkage rod and the head moving mechanism to move, to enable the head moving mechanism to perform three-point clamping, simultaneously controlling the middle moving mechanism to lift, and controlling the dynamic magnetic adhesion wheels of the middle moving mechanism to lift; and
controlling the climbing inspection robot to move forward, to enable the middle moving mechanism to cross the obstacle, and controlling a tail moving mechanism to be ready to lift; then, controlling the middle moving mechanism to return to an original traveling state and the tail moving mechanism to lift to cross the obstacle; and finally, controlling the tail moving mechanism to return to the original traveling state.

As an implementation, before controlling the attitude of the climbing inspection robot, an attitude adjustment action is determined by using a deep reinforcement learning method based on the currently sensed obstacle information and the obstacle distance, where a formula of a reward function of the deep reinforcement learning method is:

$$R = {α}_{1} \frac{A}{{A}_{m ax}} + {α}_{2} {e}^{- σ ( {\sum }_{j = 1}^{k} \vert {d}_{j} - {d}_{target} \vert )} - {α}_{3} ( \vert ϕ - {ϕ}_{stable} \vert + \vert θ - {θ}_{stable} \vert ) - {α}_{4} \frac{P}{{P}_{m ax}} ;$$

wherein, A is a normalized value of a current contact area of the dynamic magnetic adhesion wheels with a value range of [0,1] and is used for measuring an attachment state between the dynamic magnetic adhesion wheels and the steel structure; Aₘₐₓ denotes a theoretical maximum contact area and is used for normalization processing; weight coefficients α₁, α₂, α₃, and α₄ are weights for balancing contact area optimization, attitude stability, distance adaptability, and energy consumption; dⱼ is a real-time distance measurement value of a j^{th} distance measurement element, and k represents a number of the distance measurement elements; d_{target} is an ideal distance measurement value, and σ is a smoothing parameter of a distance measurement deviation; attitude angles φ and θ represent a pitch angle and a roll angle of the current attitude; φ_{stable} and θ_{stable} are a pitch angle and a roll angle that correspond to an ideal stable attitude respectively; and P is current power consumption, and Pₘₐₓ is a maximum power consumption threshold, which are used for normalizing power consumption data.

As an implementation, an adjustment angle of the wrist joint is calculated according to a distance between a wheel face of the dynamic magnetic adhesion wheel and a surface of the steel structure, to enable the dynamic magnetic adhesion wheel to actively attach to the steel structure; and a calculation formula of the adjustment angle θ_{wrist} of the wrist joint is:

$${θ}_{wrist} = arccos ( \frac{h - s}{L} ) ;$$

wherein, s is the distance between the wheel face of the dynamic magnetic adhesion wheel and the surface of the steel structure; h is a vertical distance between an axis of the wrist joint and the surface of the steel structure; and L is a length between the wrist joint and the wheel face of the dynamic magnetic adhesion wheel.

As an implementation, the control unit at least includes one or more processors, a memory, and a computer program stored on the memory and executable on the one or more processors, and when the one or more processors execute the computer program, the control unit executes the following path planning steps:
acquiring a steel structure model, dividing a surface of a steel structure roof into a plurality of triangular mesh elements, and determining visibility of each observation point to all the triangular mesh elements;
based on the visibility of each observation point to all the triangular mesh elements, by using a minimum number of the observation points as an objective, and under a steel structure attachment constraint and a grid full coverage constraint, after a plurality of observation points are obtained through optimization, performing edge weight assignment according to a path distance, a passage width, and an obstacle density, to form a spatial observation map; based on the spatial observation map, introducing a Floyd-Warshall algorithm through a virtual node, to obtain a shortest adjacency matrix; and by using each observation point in the spatial observation map as a node, using a shortest path distance in the shortest adjacency matrix as an edge weight value, and using the virtual node as a start point and an end point, constructing a traveling salesman problem (TSP) extended graph;
inputting the constructed traveling salesman problem (TSP) extended graph into a reinforcement learning policy network that is based on a graph neural network, and outputting an optimal path and a related action instruction of the climbing robot; and
controlling the climbing mechanism to act according to the output action instruction, to enable the climbing robot to climb and move according to the output optimal path.

As an implementation, the visibility of each observation point to all the triangular mesh elements is determined through the following constraints:
a detection inclination angle constraint of a visual sensor:

$${β}_{k , i} = arccos ( \frac{( {P}_{i} - {T}_{k} ) \cdot {n}_{k}}{‖ {P}_{i} - {T}_{k} ‖ \cdot ‖ {n}_{k} ‖} ) ;$$

wherein, nₖ is a normal vector of a k^{th} triangular mesh element, Tₖ is a centroid of the k^{th} triangular mesh element, Pᵢ is an i^{th} observation point, and β_{k,i} is an included angle formed between a connecting line that is between Pᵢ and Tₖ and nₖ;
a detection depth constraint of the visual sensor: disₘᵢₙ≤(Pᵢ−Tₖ)·nₖ≤disₘₐₓ, wherein the disₘᵢₙ represents a minimum visual depth of the visual sensor, and the disₘₐₓ represents a maximum visual depth of the visual sensor; and
an occlusion-free constraint: there is no occlusion between the observation point Pᵢ and the centroid Tₖ of the triangular mesh element.

As an implementation, the steel structure attachment constraint is:

gᵢ(v)=ƒᵢ(v)=0;
wherein, a support on the surface of each climbable steel structure roof is abstracted into a curve, and lᵢ represents a spatial equation of an i^{th} curve; v represents spatial coordinates of the climbing robot; gᵢ(v) represents that the climbing robot is located on the i^{th} curve; and ƒᵢ(v) represents a spatial distance between the climbing robot and the i^{th} curve, that is:

ƒᵢ(v)=∥v−lᵢ∥.

As an implementation, the grid full coverage constraint is:

$${\sum }_{i = 1}^{n} {r}_{i}^{j} \geq 1 ∀ j ∈ \{ 1 , 2 , … , k \} ;$$

wherein, k represents a number of the triangular mesh elements, and n represents a number of the observation points; and a binary variable

$${r}_{i}^{j}$$

represents visibility of an observation point Pᵢ to a j^{th} triangular mesh element, and if

$${r}_{i}^{j} = 1 ,$$

it is represented that the j^{th} triangular mesh element is visible at the observation point Pᵢ. As an implementation, the edge weight assignment is represented as:

wᵢⱼ=α·dᵢⱼ+β·ƒᵢⱼ+γ·oᵢⱼ;
wherein, α, β, and γ are all weights; wᵢⱼ is a priority from an i^{th} observation point Pᵢ to a j^{th} observation point Pⱼ; dᵢⱼ represents a path distance from the i^{th} observation point Pᵢ to the j^{th} observation point Pⱼ; ƒᵢⱼ represents a passage width of a path from the i^{th} observation point Pᵢ to the j^{th} observation point Pⱼ; and oᵢⱼ represents an obstacle density on the path from the i^{th} observation point Pᵢ to the j^{th} observation point Pᵢ.

As an implementation, the control method of a climbing inspection robot capable of self-adaptive obstacle crossing in multiple scenarios further includes: the control unit acquiring positioning information of ultra-wideband and an inertial measurement unit, to obtain positioning of the climbing robot in combination with the optimal path of the climbing robot through square root unscented Kalman filter.

According to a third aspect of the present invention, a non-transitory computer-readable storage medium is provided, having a computer program stored thereon, where the program is executed by a processor, and the program, when executed by the processor, implements the steps in the above control method of a climbing inspection robot capable of self-adaptive obstacle crossing in multiple scenarios.

According to a fourth aspect of the present invention, a computer device is provided, including a memory, a processor, and a computer program stored on the memory and executable on the processor, where when executing the program, the processor implements the steps in the above control method of a climbing inspection robot capable of self-adaptive obstacle crossing in multiple scenarios.

The present invention has the following beneficial effects:
(1) The present invention provides an electromagnetic adhesion climbing structure based on multi-joint driving and a deformable mechanism for the problem of the hindered movement of the inspection robot caused by complex geometrical connections and various obstacles of the steel structure. By using the multi-DOF spherical servo to drive the inter-module linkage rod, and in combination with the dynamic magnetic adhesion assembly, the maneuverability and adaptability of the robot in complex truss and grid structures are improved, which can achieve a stable movement with a peak of 4 m/min.
(2) The present invention determines the next to-be-executed obstacle avoidance operation based on the currently sensed obstacle information and the detected obstacle distance, and then controls the next attitude of the climbing inspection robot based on the current attitude of the climbing inspection robot, to enable the climbing inspection robot to successfully avoid the obstacle. In addition, during each step, at least two sections of bodies are on the steel structure, thereby ensuring the stability and safety of the climbing inspection robot during inspection on the steel structure.
(3) The present invention establishes a mathematical model with the minimum number of the observation points as the objective and the component steel structure attachment and the grid full coverage as the constraints, thereby implementing the efficient visual full coverage of the observation point to the steel structure roof. Based on this, based on the optimal Hamiltonian path theory, and by combining the virtual node with the Floyd-Warshall algorithm, the traveling salesman problem (TSP) extended graph is constructed, and an equivalence relation between the traveling salesperson problem path and the Hamiltonian path is established, thereby implementing the full coverage path planning of the climbing inspection robot to the high-rise steel structure roof.
(4) The present invention introduces a PI-LPM location probability model based on IMU and UWB multi-source information integrated positioning solutions and performs positioning information fusion based on SR-UKF, thereby accurately positioning the climbing robot.

The additional advantages of the present invention will be partially presented in the following description, some of which will become apparent from the following description, or learned through practice of the present invention.

### BRIEF DESCRIPTION OF THE DRAWINGS

The accompanying drawings of the specification which constitute a part of the present invention provide further understanding of the present invention. The schematic examples of the present invention and description thereof are intended to explain the present invention and are not intended to constitute an improper limitation to the present invention.

FIG. 1 is a schematic structural diagram of a climbing inspection robot capable of self-adaptive obstacle crossing in multiple scenarios according to an embodiment of the present invention;

FIG. 2 is a schematic structural diagram of a three-point clamping structure according to an embodiment of the present invention;

FIG. 3 is a schematic structural diagram of a multi-DOF active spherical servo joint according to an embodiment of the present invention;

FIG. 4 is a schematic state diagram of a wrist joint according to an embodiment of the present invention;

FIG. 5 is another schematic state diagram of a wrist joint according to an embodiment of the present invention;

FIG. 6 is a schematic structural diagram of a self-adaptive passive wheel assembly according to an embodiment of the present invention;

FIG. 7 is a schematic structural diagram of a dynamic magnetic adhesion wheel according to an embodiment of the present invention;

FIG. 8 is a three-dimensional diagram of a permanent magnet protection mechanism in an inactive state according to an embodiment of the present invention;

FIG. 9 is a side view of a permanent magnet protection mechanism in an inactive state according to an embodiment of the present invention;

FIG. 10 is a three-dimensional diagram of a permanent magnet protection mechanism in an active state according to an embodiment of the present invention;

FIG. 11 is a side view of a permanent magnet protection mechanism in an active state according to an embodiment of the present invention; and

FIG. 12 is an effect diagram of magnetic distribution optimization according to an embodiment of the present invention.

1. distance measurement element; 2. dynamic magnetic adhesion wheel; 3. wrist joint; 4. side-arm linkage rod; 5. inter-module linkage rod; 6. body connecting arm; 7. depth camera; 8. gimbal; 9. positioning system; 10. multi-DOF active spherical servo joint; 11. LED illumination system; 12. obstacle sensing element; 13. self-adaptive passive wheel assembly; 1301. self-adaptive spring; 1302. wheel carrier; 1303. bearing; 1304. magnetic adhesion passive wheel; 1305. connecting plate; 1001. active joint servo; 1002. rigid joint connecting rod; 1003. flexible housing; 1004. coupling hinge; 301. rigid connecting rod; 302. servo; 303. rigid housing; 3041. first bevel gear; 3042. second bevel gear; 3043. third bevel gear; 14. support frame; 15. steel structure; 201. flexible wheel face; 202. Halbach array electromagnet; 203. connecting disc; 204. permanent magnet; 205. first servo rotating mechanism; 20. second servo rotating mechanism; 207. first connecting member; 208. L-shaped connecting rod; 209. second connecting member; 2091. connecting plate; 2092. connecting rod; 2010. sliding groove.

### DETAILED DESCRIPTION

The present invention is further described with reference to the accompanying drawings and examples.

It should be noted that the following detailed description is exemplary and aims to further describe the present invention. Unless otherwise specified, all technical and scientific terms used herein have the same meanings as those generally understood by those of ordinary skill in the art to which the present invention belongs.

It should be noted that the terms used herein are only for describing the examples rather than for limiting the exemplary examples of the present invention. As used herein, unless otherwise stated clearly in the context, a singular form is intended to include a plural form thereof. In addition, it should be understood that the terms “comprise/comprising” and/or “include/including” as used herein indicate the presence of features, steps, operations, components, assemblies, and/or combinations thereof.

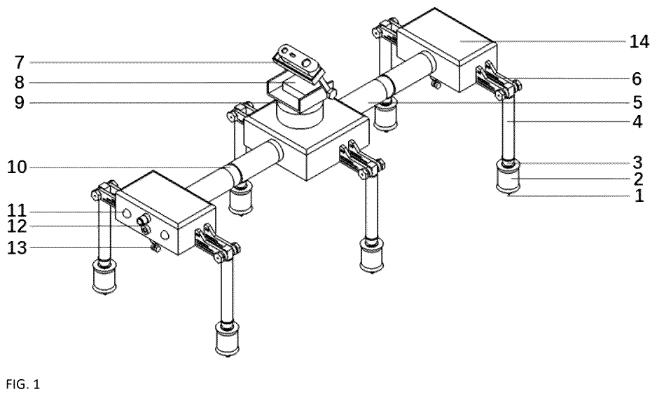

FIG. 1 is a schematic structural diagram of a climbing inspection robot capable of self-adaptive obstacle crossing in multiple scenarios according to an embodiment of the present invention. As shown in FIG. 1, a climbing inspection robot capable of self-adaptive obstacle crossing in multiple scenarios according to an embodiment of the present invention includes: a climbing inspection robot capable of self-adaptive obstacle crossing in multiple scenarios, including: at least three moving mechanisms, wherein any two adjacent moving mechanisms are connected by an inter-module linkage rod 5; and a middle-segment portion of the inter-module linkage rod 5 is provided with a multi-DOF active spherical servo joint 10.

Each of the at least three moving mechanisms at least includes: a control unit, a support frame 14, a sensing module, and a climbing mechanism. The control unit is arranged in the support frame 14, and both the sensing module and the climbing mechanism are communicatively connected to the control unit.

The climbing mechanism at least includes a pair of side-arm linkage rods 4, which are symmetrically arranged on two sides of the support frame 14. A tail end of each of the side-arm linkage rods 4 is connected to a dynamic magnetic adhesion wheel 2 through a wrist joint 3.

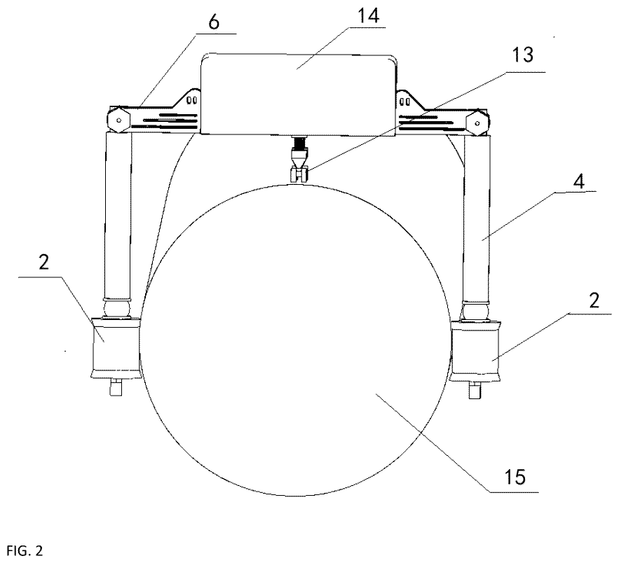

A self-adaptive passive wheel assembly 13 is further arranged at a central position of the bottom of the support frame 14. The self-adaptive passive wheel assembly 13 and dynamic magnetic adhesion wheels 2 disposed at the two sides of the support frame jointly clamp a steel structure 15 and form a three-point clamping structure, as shown in FIG. 2.

The sensing module at least includes an obstacle sensing element 12 and a distance measurement element 1, which are used for sensing obstacle information and detecting an obstacle distance respectively, and transmitting the obstacle information and the obstacle distance to the control unit.

It should be noted herein that FIG. 1 takes three moving mechanisms as an example and only illustrates the structural composition of the sensing module on one of the moving mechanisms The specific compositions of the sensing modules on the other moving mechanisms are the same as the structural composition of the sensing module shown in FIG. 1, which are not shown in FIG. 1. In addition, since there is an occlusion relationship in FIG. 1, the self-adaptive passive wheel assembly on a middle moving mechanism is not shown in FIG. 1.

During specific implementations, the side-arm linkage rods 4 are further connected to the two sides of the support frame in a hinged manner through body connecting arms 6.

In FIG. 1, the obstacle sensing element 12 is fixed at a set position on the support frame of each of a head moving mechanism and a tail moving mechanism of the climbing inspection robot capable of self-adaptive obstacle crossing in multiple scenarios. The distance measurement element 1 is mounted on each of the dynamic magnetic adhesion wheels 2. LED illumination systems 11 are further arranged around the obstacle sensing element 12 and are used for providing corresponding brightness for the obstacle sensing element 12.

In some other examples, the sensing module further includes a depth camera 7, and the depth camera 7 is used for collecting an image during inspection and transmitting the image to the control unit. The depth camera 7 is mounted on the middle moving mechanism through a gimbal 8.

In some examples, a positioning system 9 is further mounted on the middle moving mechanism and is used for positioning current position information of the climbing inspection robot.

In the present example, an outer side of the dynamic magnetic adhesion wheel may be provided with a flexible silicone wheel face with protrusions. The flexible silicone wheel face with protrusions and the self-adaptive passive wheel assembly together forms a stable three-point clamping configuration, which can increase a magnetic adhesion area and stability.

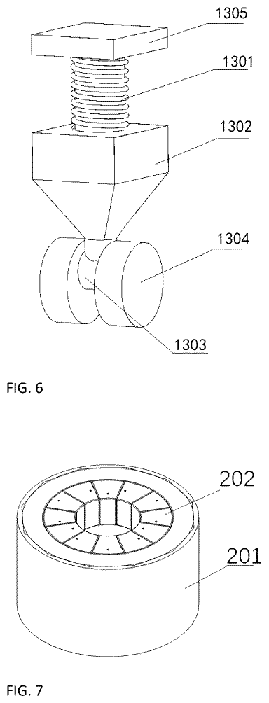

In the present example, as shown in FIG. 6, the self-adaptive passive wheel assembly 13 includes a self-adaptive spring 1301, a wheel carrier 1302, a bearing 1303, two magnetic adhesion passive wheels 1304, and a connecting plate 1305. One end of the self-adaptive spring 1301 is connected to the connecting plate 1305, and the other end is connected to a top end of the wheel carrier 1302. The connecting plate 1305 is fixed at the bottom of the support frame 14. The bearing 1303 is fixed at a tail end of the wheel carrier 1302, and the magnetic adhesion passive wheels 1304 are mounted at two ends of the bearing 1303. The self-adaptive spring can enable the robot to be capable of directly and self-adaptively passing small obstacles encountered during inspection.

Specifically, the dynamic magnetic adhesion wheel 2 includes a flexible wheel face 201, and Halbach array electromagnets 202 are wrapped in the flexible wheel face 201, as shown in FIG. 7. Coils are wound outside the Halbach array electromagnets, and the coils are connected to a power supply module. The Halbach array electromagnets are used for generating magnetic field intensity when the coils are powered on, to enable the magnetic adhesion wheel to adhere to the steel structure 15.

During specific implementations, an adhesion force of the dynamic magnetic adhesion wheel is determined by the magnetic field intensity, and the magnetic field intensity is controlled by an output current of the power supply module. The output current of the power supply module is controlled by dynamically adjusting a duty cycle of a PWM signal. The duty cycle of the PWM signal is obtained through dynamic adjustment by using a fuzzy logic control algorithm according to a current adhesion force, a set target adhesion force, and an external load change.

Formulas of dynamically adjusting the duty cycle D of the PWM signal by using the fuzzy logic control algorithm are:

$$D = \frac{{\int }_{z} z \cdot {μ}_{out} ( z ) dz}{{\int }_{z} {μ}_{out} ( z ) dz} ;$$

$${μ}_{out} ( z ) = max ( {μ}_{R 1} ( z ) , {μ}_{R 2} ( z ) , … , {μ}_{Rn} ( z ) ) ;$$

$${μ}_{Ri} ( z ) = min ( {μ}_{A} ( x ) , {μ}_{B} ( y ) ; i = 1 , 2 , … , n ;$$

$${μ}_{A} ( x ) = \{ \begin{matrix}1 , & x \leq a \\ \frac{b - x}{b - a} , & a < x \leq b \\ 0 , & x > b\end{matrix} ;$$

$${μ}_{B} ( y ) = \{ \begin{matrix}\frac{y - c}{d - c} , & c \leq y < d \\ 1 , & y \geq d\end{matrix} ;$$

wherein, z represents a possible value range of an output variable, and μₒᵤₜ(z) represents a multi-rule fuzzy inference membership function; x and y are the adhesion force and the load change respectively; μ_{Ri}(z) represents a fuzzy inference membership function of the climbing inspection robot under an i^{th} attitude; n represents a number of attitude types of the climbing inspection robot; μ_{A}(x) and μ_{B}(y) represent membership functions of the adhesion force and the load change respectively; and a, b, c, and d are corresponding variable parameters of the climbing inspection robot under different attitudes.

The attitude of the climbing inspection robot includes: a normal traveling state, an obstacle crossing state, a set angle component switching state, a set obstacle passing state, and an emergency stop state.

For example, during normal traveling, the required adhesion force is low and stable, and the load change range is small, taking:
a=0.5g, b=1g, c=0.5g, d=1.5g;
in the obstacle crossing state, the required adhesion force increases, and the load change amplitude is large, taking:
a=1g, b=1.5g, c=1g, d=2g;
during set angle component switching, a required adhesion force is high, and a load change is intense, taking:
a=1.5g, b=2g, c=1.5g, d=2.5g;
during set obstacle passing (for example, vertical climbing or horizontal plane sharp turning), the required adhesion force is extremely high, and the load may have an extremum, taking:
a=2g, b=3g, c=2.5g, d=4g;
under an emergency stop (for example, an extreme tilt), the adhesion force needs to be the maximum, and the load fluctuation range is larger, taking:
a=2.5g, b=4g, c=3g, d=5g;
wherein, g represents the gravity of the robot itself.

It should be noted herein that the four parameters a, b, c, and d may be specifically set according to actual situations.

In the present example, the adhesion force may be divided into three ranges, which respectively are: a low adhesion force, a moderate adhesion force, and a high adhesion force. The three ranges are determined by using the two parameters a and b. When less than or equal to a, the adhesion force belongs to the low adhesion force; when greater than a and less than or equal to b, the adhesion force belongs to the moderate adhesion force; and when greater than b, the adhesion force belongs to the high adhesion force. The load change amplitude may be determined by using the two parameters c and d. When greater than or equal to c and less than d, the load change amplitude belongs to a load stabilization situation; and when greater than d, the load change amplitude belongs to a load increase situation.

For example, if the adhesion force is “low adhesion force” and the load is “increase”, the PWM signal should be adjusted to a high level;

if the adhesion force is “moderate adhesion force” and the load is “stabilization”, the PWM signal is maintained at a moderate level; and
if the adhesion force is “high adhesion force”, the PWM signal is adjusted to a low level.

Then, by using a fuzzy inference system, a fuzzy value of an input variable is converted and output as a fuzzy value of the PWM signal, and results of multiple rules are combined for inference. Finally, through defuzzification processing, the results obtained through fuzzy inference are converted into actual PWM duty cycles, thereby adjusting the current of the electromagnet, accurately controlling the magnetic field intensity, and optimizing the performance and stability of electromagnetic adhesion.

In the present example, the PWM signal PWM_{signal} is adjusted through the actual duty cycle D, and a formula thereof is: PWM_{signal}=D·T; wherein, T is a period of the PWM signal, and finally, the current of the electromagnet is controlled by adjusting the duty cycle D, thereby accurately implementing the optimization of the magnetic field intensity and the stability of the electromagnetic adhesion.

Specifically, the process of controlling the current of the electromagnet by adjusting the duty cycle D is as follows:
given a maximum current Iₘₐₓ when the duty cycle D=100%, in combination with the duty cycle D, and according to I_{avg}=D·Iₘₐₓ, the current I_{avg} of the electromagnet can be obtained.

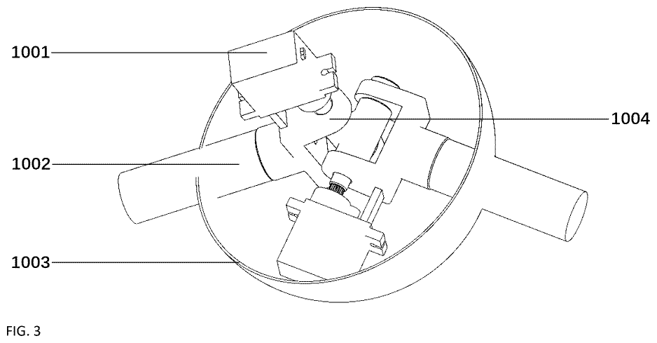

As shown in FIG. 3, the multi-DOF active spherical servo joint 10 includes a flexible housing 1003, two active joint servos 1001, and two rigid joint connecting rods 1002. All the active joint servos 1001 are disposed in the flexible housing 1003, the active joint servos 1001 and the rigid joint connecting rods 1002 are connected through coupling hinges 1004, and the active joint servos 1001 and the rigid joint connecting rods 1002 that correspond to each other are coupled and hinged. One end of each of the rigid joint connecting rods 1002 further extends out of the flexible housing 1003 and is connected to the inter-module linkage rod. In this way, the robot may deform to adjust the attitude, to implement inspection paths passing multiple complex steel structures.

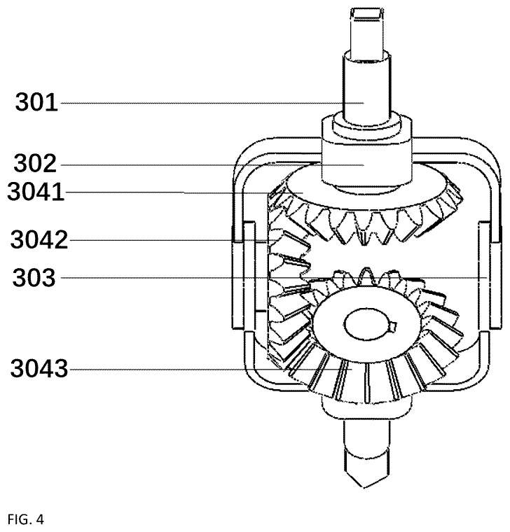

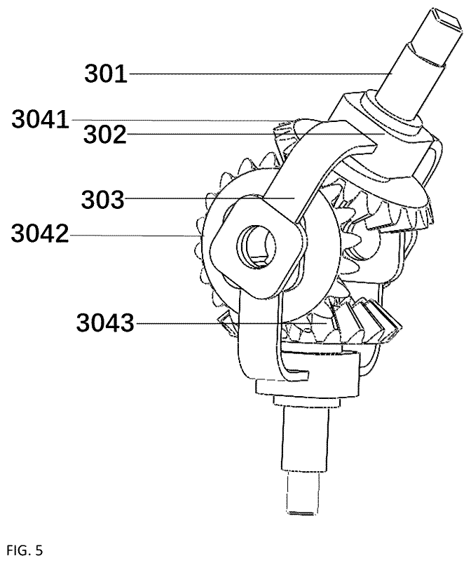

In the present example, as shown in FIG. 4 and FIG. 5, the wrist joint 3 includes a rigid housing 303 and bevel gears. The bevel gears include a first bevel gear 3041, a second bevel gear 3042, and a third bevel gear 3043. Both the first bevel gear 3041 and the third bevel gear 3043 are engaged with the second bevel gear 3042. The first bevel gear 3041 and the third bevel gear 3043 are connected to a servo 302 respectively, and each servo 302 is connected to a rigid connecting rod 301. The servo is used for driving the corresponding bevel gear to be in engagement transmission with the second bevel gear. In this way, the servo drives the bevel gear to rotate, thereby adjusting the pose of the dynamic magnetic adhesion wheel to attach to the steel structure.

In some other examples, a permanent magnet protection mechanism is further disposed in the support frame. The permanent magnet protection mechanism is in an inactive state. The permanent magnet protection mechanism is connected to a control module. The control module is used for acquiring the magnetic field intensity of the Halbach array electromagnets and comparing the magnetic field intensity with a preset magnetic field intensity threshold, to control the permanent magnet protection mechanism to switch to an active state, so that the climbing inspection robot is adhered to the steel structure.

When the climbing inspection robot is in normal inspection, the permanent magnet protection mechanism is in the inactive state. When the climbing inspection robot is powered off due to insufficient electricity or sudden emergencies, the permanent magnet protection mechanism is switched to the active state.

In some examples, the permanent magnet protection mechanism includes a connecting disc, a permanent magnet, and a driving module. An upper end of the connecting disc is fixedly connected to the interior of the climbing robot, a lower end of the connecting disc is connected to the driving module, the driving module is connected to the permanent magnet and the control module, and the driving module is used for driving the magnet to rotate under the action of the control module. When the permanent magnet protection mechanism is in the inactive state, the permanent magnet is on one side away from the steel structure. When the permanent magnet protection mechanism is switched to the active state, the driving module is used for driving the permanent magnet to rotate to one side close to the steel structure, to adhere to the steel structure.

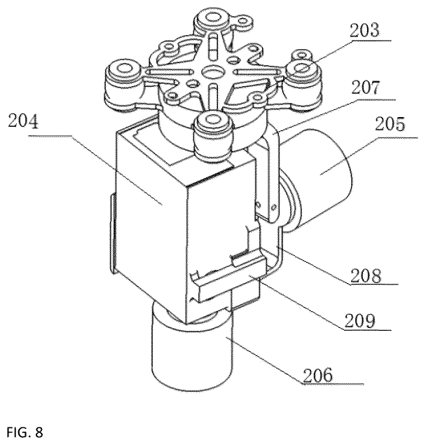

In some examples, as shown in FIG. 8 to FIG. 12, the permanent magnet protection mechanism includes a connecting disc 203, a permanent magnet 204, and a driving module. An upper end of the connecting disc 203 is fixedly connected to the interior of the climbing robot, a lower end of the connecting disc 203 is connected to the driving module, the driving module is connected to the permanent magnet 204 and the control module, and the driving module is used for driving the permanent magnet 204 to rotate under the action of the control module. When the permanent magnet protection mechanism is in the inactive state, the permanent magnet 204 is on one side away from the steel structure. When the permanent magnet protection mechanism is switched to the active state, the driving module is used for driving the permanent magnet 204 to rotate to one side close to the steel structure, to adhere to the steel structure.

The driving module includes a first servo rotating mechanism 205 and a second servo rotating mechanism 206. Both the first servo rotating mechanism 205 and the second servo rotating mechanism 206 are connected to the control module. The first servo rotating mechanism 205 is fixedly connected to the connecting disc 203 through a first connecting member 207. An output shaft of the first servo rotating mechanism 205 is connected to the second servo rotating mechanism 206 through an L-shaped connecting rod 208. An output shaft of the second servo rotating mechanism 206 is connected to the permanent magnet 204 through a second connecting member 209. The second connecting member 209 includes a connecting plate 2091 and connecting rods 2092 fixed on two sides. Two opposite side faces of the permanent magnet 204 are provided with sliding grooves 2010, and the two connecting rods 2092 are clamped into the sliding grooves 2010 of the permanent magnet 204 correspondingly. The output shaft of the second servo rotating mechanism 206 is connected to one side face of the connecting plate 2091.

The second servo rotating mechanism 206 is used for driving the second connecting member 209 to rotate under the control of the control module, thereby driving the permanent magnet 204 to rotate. The first servo rotating mechanism 205 is used for driving the L-shaped connecting rod 208 to rotate under the control of the control module, thereby driving the second servo rotating mechanism 206 and the second connecting member 209 connected to the second servo rotating mechanism to jointly rotate, so that the permanent magnet 204 moves from one side away from the steel structure to one side close to the steel structure.

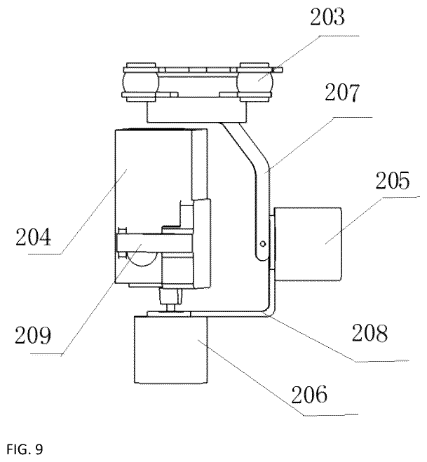

When the climbing robot works normally, the permanent magnet protection mechanism is in the inactive state. As shown in FIG. 8 and FIG. 9, the second servo rotating mechanism 206 is located at the bottom of the permanent magnet 4, and the second connecting member 209 supports the permanent magnet 204. At this time, the permanent magnet 204 is away from the steel structure.

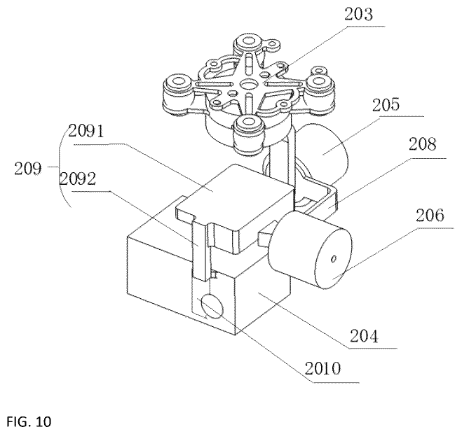

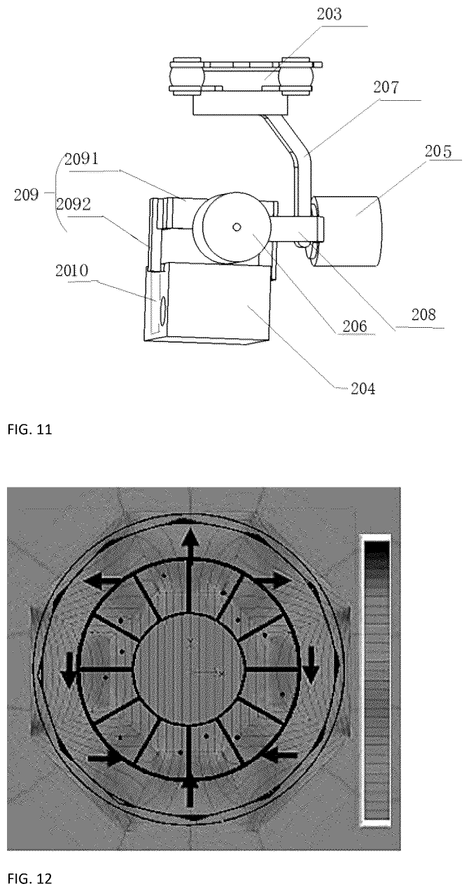

When the climbing inspection robot is powered off due to insufficient electricity or sudden emergencies, the permanent magnet protection mechanism is switched to the active state. As shown in FIG. 10 and FIG. 11, the control module controls the second servo rotating mechanism 206 to drive the second connecting member 209 to rotate, thereby driving the permanent magnet 204 to rotate. A side face of the permanent magnet 204 connected to the connecting plate 2091 is set as a face A, and a face opposite to the face A is set as a face B. When the face B of the permanent magnet 204 faces outward, the second servo rotating mechanism 206 stops rotating. The control module controls the first servo rotating mechanism 205 to drive the L-shaped connecting rod 208 to rotate, thereby driving the second servo rotating mechanism 206 and the second connecting member 209 connected to the second servo rotating mechanism to jointly rotate. When the face B of the permanent magnet 204 faces downward, the first servo rotating mechanism 205 stops rotating. At this time, due to the gravity of the permanent magnet 204, the inter-module linkage rods 2092 move along the sliding grooves 2010 on the two sides of the permanent magnet 204 until the inter-module linkage rods move to tail ends of the sliding grooves 2010 and stop. It should be noted herein that the inter-module linkage rods 2092 are always disposed in the sliding grooves 2010.

Both the connecting disc and the permanent magnet herein are implemented by using the existing structures. The first servo rotating mechanism and the second servo rotating mechanism may be selected with corresponding servo models according to specific situations, which are not described in detail herein again.

In the present example, the coils adopt an alternating magnetic polarity arrangement, that is, an NSNS coil arrangement is adopted, thereby ensuring that an output side forms a strong magnetic field.

Specifically, through a specific arrangement of magnet magnetization directions, the Halbach array significantly enhances the magnetic field on the output side while effectively shielding the magnetic field on the opposite side. A theoretical basis thereof is a periodic magnetization vector, a magnetic field distribution can be described by an exponential relationship, and a formula is as follows: B(X, Y)=B₀e^{kX}. B₀ represents maximum magnetic field intensity,

$$k = \frac{2 π}{λ}$$

is a wave number and is related to a magnetization period λ, and X, Y are spatial coordinates and describe the distribution of the magnetic field in the plane. The effect of magnetic distribution optimization is as shown in FIG. 12.

In one or more examples, design parameters of both the permanent magnet protection mechanism and the magnetic adhesion wheel determine performance indicators of a lightweight heavy-load dynamic magnetic adhesion apparatus of a climbing robot. The design parameters include geometrical features (for example, structural complexity and assembly sizes), material allocation features (for example, density, elastic modulus, Poisson's ratio, and yield strength), and mechanical features (for example, stress concentration factors). The performance indicators include strength and mass.

The optimal design parameters of both the permanent magnet protection mechanism and the magnetic adhesion wheel enable the lightweight heavy-load dynamic magnetic adhesion apparatus of the climbing robot to have maximum strength and minimum mass.

In some specific examples, a prediction model may be trained using a machine learning algorithm by collecting historical optimization data and extracting key features from the data, to predict the performance of the lightweight heavy-load dynamic magnetic adhesion apparatus of the climbing robot under different design solutions. For example, performance prediction is performed by using a gradient boosting regression tree (GBRT), and the target is to construct an efficient regression model to predict the performance of different design solutions.

A model training process includes the following steps:
performing normalization processing on the historical optimization data, defining an input feature H=[C_{g}, E, Kₜ], and outputting as a performance indicator; reducing feature dimensions by using principal component analysis, and retaining features with a cumulative variance contribution rate reaching 95%; using the gradient boosting regression tree

$$f ( H ) = {\sum }_{m = 1}^{M} {α}_{m} {h}_{m} ( H ) ,$$

wherein hₘ(H) is an m^{th} base learner; αₘ is a weight corresponding to the m^{th} base learner; M is a number of the base learners; and C_{g}, E, Kₜ are the structural complexity, the elastic modulus, and the stress concentration factor respectively; optimizing hyper-parameters through grid search, for example, a depth and a learning rate of the tree; and finally, estimating a mean square error of the model by using 10-fold cross validation.

In some other examples, a numerical method such as finite element analysis (FEA) is further used to perform isotropic analysis on the structure, to ensure uniformity and rationality of material allocation.

A database is constructed, which stores content including material attributes (density, elastic modulus, Poisson's ratio, yield strength, and the like), geometrical and structural information (assembly sizes and loading conditions), external environmental conditions (wind loads and temperature changes), and historical optimization data (design solutions and performance). In the finite element analysis (FEA), by establishing a model, grid partition, and applying a boundary condition and a load, the isotropic performance of the structure is analyzed.

In a specific method of isotropic validation, directional independence testing is first performed, and by applying uniform loads in different directions to the structure, stress-strain responses of the material in multiple directions are analyzed, to calculate a stress deviation ratio:

$${R}_{σ} = \frac{{σ}_{max} - {σ}_{min}}{{σ}_{avg}} ,$$

wherein σₘₐₓ represents maximum stress in different directions; σₘᵢₙ represents minimum stress in different directions; and, σ_{avg} represents an average value of stress in various directions.

If R_{σ}≤ϵ, wherein ϵ is a set threshold, it is considered that the stress responses of the material meet isotropic requirements. Then, numerical calculation results are compared, loads are applied to the structure in different directions x, y, and z, elastic moduli Eₓ, E_{y}, and E_{z} in corresponding directions are calculated, and consistency of the elastic moduli is validated:

$${E}_{x} = \frac{{σ}_{x}}{{ε}_{x}} , {E}_{y} = \frac{{σ}_{y}}{{ε}_{y}} , and {E}_{z} = \frac{{σ}_{z}}{{ε}_{z}} ,$$

wherein σₓ, σ_{y}, and σ_{z} are stress in the directions x, y, and z respectively; and εₓ, ε_{y}, and ε_{z} are strain in the directions x, y, and z.

If

$$\frac{\vert {E}_{x} - {E}_{y} \vert}{{E}_{x}} \leq δ ,$$

elastic performance of the material in different directions can meet the consistency, wherein δ is a set threshold. Finally, stiffness matrix eigenvalue validation is performed.

A stiffness matrix D_{stiffness} of the material is a symmetric matrix, and a stiffness characteristic may be analyzed through an eigenvalue:

$${D}_{stiffness} = [ \begin{matrix}{D}_{11} & {D}_{12} & {D}_{13} \\ {D}_{12} & {D}_{22} & {D}_{23} \\ {D}_{13} & {D}_{23} & {D}_{33}\end{matrix} ] .$$

Eigenvalues λ₁, λ₂, and λ₃ are calculated, to validate whether the following condition holds:

$$\frac{max ( {λ}_{1} , {λ}_{2} , {λ}_{3} ) - min ( {λ}_{1} , {λ}_{2} , {λ}_{3} )}{mean ( {λ}_{1} , {λ}_{2} , {λ}_{3} )} \leq η ;$$

wherein η is a set tolerance value.

If the condition is met, the stiffness matrix exhibits consistent performance in various directions, meeting the isotropic requirements.

In some other examples, a dynamically adjusted penalty function is further provided, to reflect the performance requirements of the lightweight heavy-load dynamic magnetic adhesion apparatus of the climbing robot. A formula of the dynamically adjusted penalty function is:

$$P ( t ) = α ( t ) \cdot {\int }_{0}^{{T}_{0}} [ β ( t ) \cdot sin ( γ \cdot x ( t ) ) + log ( 1 + {\vert u ( t ) \vert}^{δ} ) ] \cdot f ( x ( t ) , u ( t ) ) dt ;$$

wherein, α(t) is a dynamic adjustment factor and reflects time-varying requirements of a current state of the lightweight heavy-load dynamic magnetic adhesion apparatus of the climbing robot; β(t) is a state weight coefficient and is used for dynamically adjusting a degree of attention paid to structural performance at different stages; sin(γ·x(t)) is a periodic fluctuation term of a state variable, and γ is a fluctuation frequency factor and is used for enhancing nonlinear sensitivity of state variable changes; log(1+|u(t)|^{δ}) is a control variable weight function, which reflects an impact of external loading on performance evaluation through nonlinear amplification of an input variable, and δ is an adjustment index; ƒ(x(t), u(t)) is a comprehensive evaluation function and is used for representing a coupling relationship between a structural state variable x(t) and a control variable u(t), and a specific formula thereof may be obtained by performing regression fitting through a historical data set; and T₀ is an evaluation time window and is used for limiting a calculation range and ensuring real-time performance. A structural state is evaluated through sensor data, and parameters of α(t) and β(t) are dynamically adjusted to adapt to the latest requirements. When the state is poor, α(t) is increased or a shape of β(t) is adjusted to focus more on a performance problem. When the state is good, α(t) is decreased or β(t) is smoothed to reduce penalty sensitivity.

In some other examples, the structure of the permanent magnet protection mechanism may also be implemented by using other structures, which is not described in detail herein again.

In the present example, by using the permanent magnet protection mechanism, the phenomena of weakening of the adhesion force and falling of the climbing inspection robot that are caused by the weakening or sudden decrease in the magnetic field intensity when the climbing inspection robot is powered off due to insufficient electricity or sudden emergencies can be avoided, thereby improving the operational stability of the climbing inspection robot.

In the present example of the present invention, for the problem of limited mounted sensing devices due to high electricity consumption and an insufficient load capability of the electromagnetic adhesion climbing robot, a combined electromagnetic-permanent magnet magnetic adhesion solution is provided. A Halbach array electromagnet layout is used, the magnetic field coverage range and the adhesion force are enhanced by using magnetic field coupling, and when the magnetic field intensity does not reach the preset magnetic field intensity threshold, the permanent magnet protection mechanism is switched to the active state, so that the climbing robot is adhered to the steel structure, thereby implementing the effects of a significant increase in the load capability in a powered-on state and automatic locking and dropping prevention in a powered-off state.

In the present example of the present invention, the duty cycle of the PWM signal is dynamically adjusted by using the fuzzy logic control algorithm according to the current adhesion force, the set target adhesion force, and the external load change, to control the output current of the power supply module, so that a closed-loop control over the magnetic field intensity is implemented, and the current of the electromagnet is accurately adjusted to regulate and control the magnetic field intensity and direction, thereby generating a stable and accurate directed adhesion force and effectively lowering battery energy consumption.

In the present example of the present invention, by optimizing the design parameters of both the permanent magnet protection mechanism and the magnetic adhesion wheel, the lightweight heavy-load dynamic magnetic adhesion apparatus of the climbing robot has maximum strength and minimum mass, so that the lightweight design of the structure of the climbing robot is implemented on the premise of meeting the strength and stiffness requirements, thereby ultimately resulting in a load-to-weight ratio of no less than 50% for the climbing robot.

A control method based on the above climbing inspection robot capable of self-adaptive obstacle crossing in multiple scenarios includes:
Step 1: determining a next to-be-executed obstacle avoidance operation according to currently sensed obstacle information and a detected obstacle distance; and
Step 2: controlling an attitude of the climbing inspection robot based on a current attitude and the next to-be-executed obstacle avoidance operation of the climbing inspection robot, to enable the climbing inspection robot to avoid an obstacle successfully;
wherein, a process of the obstacle avoidance operation is:
controlling the multi-DOF active spherical servo joint to drive the inter-module linkage rod and a head moving mechanism to move, to enable the head moving mechanism to lift, simultaneously controlling the dynamic magnetic adhesion wheels of the head moving mechanism to lift to avoid the obstacle, controlling the climbing inspection robot to move forward, to enable the head moving mechanism to cross the obstacle, and controlling a middle moving mechanism to be ready to lift;
controlling the dynamic magnetic adhesion wheel of the head moving mechanism to return to an original state to attach and adhere to a steel structure, controlling the multi-DOF active spherical servo joint to drive the inter-module linkage rod and the head moving mechanism to move, to enable the head moving mechanism to perform three-point clamping, simultaneously controlling the middle moving mechanism to lift, and controlling the dynamic magnetic adhesion wheels of the middle moving mechanism to lift; and
controlling the climbing inspection robot to move forward, to enable the middle moving mechanism to cross the obstacle, and controlling a tail moving mechanism to be ready to lift; then, controlling the middle moving mechanism to return to an original traveling state and the tail moving mechanism to lift to cross the obstacle; and finally, controlling the tail moving mechanism to return to the original traveling state.

Specifically, before controlling the attitude of the climbing inspection robot, an attitude adjustment action is determined by using a deep reinforcement learning method based on the currently sensed obstacle information and the obstacle distance, where a formula of a reward function of the deep reinforcement learning method is:

$$R = {α}_{1} \frac{A}{{A}_{max}} + {α}_{2} {e}^{- σ ( {\sum }_{j = 1}^{k} \vert {d}_{j} - {d}_{target} \vert )} - {α}_{3} ( \vert ϕ - {ϕ}_{stable} \vert + \vert θ - {θ}_{stable} \vert - {α}_{4} \frac{P}{{P}_{max}} ;$$

wherein, A is a normalized value of a current contact area of the dynamic magnetic adhesion wheels with a value range of [0,1] and is used for measuring an attachment state between the dynamic magnetic adhesion wheels and the steel structure; Aₘₐₓ is a theoretical maximum contact area and is used for normalization processing; weight coefficients α₁, α₂, α₃, and α₄ are weights for balancing contact area optimization, attitude stability, distance adaptability, and energy consumption; dⱼ is a real-time distance measurement value of a j^{th} distance measurement element, and k represents a number of the distance measurement elements; d_{target} is an ideal distance measurement value, and σ is a smoothing parameter of a distance measurement deviation; attitude angles φ and θ represent a pitch angle and a roll angle of the current attitude; φ_{stable} and θ_{stable} are a pitch angle and a roll angle that correspond to an ideal stable attitude respectively; and P is current power consumption, and Pₘₐₓ is a maximum power consumption threshold, which are used for normalizing power consumption data.

In the present example, the attitude adjustment action can be determined accurately and rapidly by using the deep reinforcement learning method, thereby improving the inspection efficiency of the climbing inspection robot.

In some examples, an active and passive self-adaptive attachment method is further used to determine an adjustment angle of the wrist joint.

Specifically, the active and passive self-adaptive attachment method is as follows: the adjustment angle of the wrist joint is calculated according to a distance between a wheel face of the dynamic magnetic adhesion wheel and a surface of the steel structure, to enable the dynamic magnetic adhesion wheel to actively attach to the steel structure; and a calculation formula of the adjustment angle θ_{wrist} of the wrist joint is:

$${θ}_{wrist} = arccos ( \frac{h - s}{L} ) ;$$

wherein, S is the distance between the wheel face of the dynamic magnetic adhesion wheel and the surface of the steel structure; h is a vertical distance between an axis of the wrist joint and the surface of the steel structure; and L is a length between the wrist joint and the wheel face of the dynamic magnetic adhesion wheel.

In one or more examples, the control unit at least includes one or more processors, a memory, and a computer program stored on the memory and executable on the one or more processors, and when the one or more processors execute the computer program, the control unit executes the following path planning steps:
acquiring a steel structure model, dividing a surface of a steel structure roof into a plurality of triangular mesh elements, and determining visibility of each observation point to all the triangular mesh elements;
based on the visibility of each observation point to all the triangular mesh elements, by using a minimum number of the observation points as an objective, and under a steel structure attachment constraint and a grid full coverage constraint, after a plurality of observation points are obtained through optimization, performing edge weight assignment according to a path distance, a passage width, and an obstacle density, to form a spatial observation map; based on the spatial observation map, introducing a Floyd-Warshall algorithm through a virtual node, to obtain a shortest adjacency matrix; and by using each observation point in the spatial observation map as a node, using a shortest path distance in the shortest adjacency matrix as an edge weight value, and using the virtual node as a start point and an end point, constructing a traveling salesman problem (TSP) extended graph;
inputting the constructed traveling salesman problem (TSP) extended graph into a reinforcement learning policy network that is based on a graph neural network, and outputting an optimal path and a related action instruction of the climbing robot; and

controlling the climbing mechanism to act according to the output action instruction, to enable the climbing robot to climb and move according to the output optimal path.

A specific process of executing the following path planning steps by the control unit is:

Step 1: studying a steel structure surface network partition policy based on a bubble meshing method, and converting a continuous visual coverage problem into a discrete grid coverage problem.

For an inspection task of the steel structure, the steel structure model is acquired, and the surface of the steel structure roof is divided into the plurality of triangular mesh elements of approximately equal sizes. A target is observed from an observation point Pᵢ, and a triangular mesh element k on the surface of the steel structure is constructed. If the following constraints are met, it is represented that a high-quality image of the triangular mesh element k may be obtained from the observation point Pᵢ, that is, the triangular mesh element is visible.
(1) A detection inclination angle constraint of a visual sensor: if a maximum cone angle of a field of view of the observation point Pᵢ is given as ϵₘ, and assuming that the centroid of the triangular mesh element k is Tₖ, and an included angle formed between a connecting line that is between Pᵢ and the centroid of the triangular mesh element Tₖ and a normal vector of the triangular mesh element is β_{k,i}, a condition that the included angle needs to meet is as the following formula:

$${β}_{k , i} = arccos ( \frac{( {P}_{i} - {T}_{k} ) \cdot {n}_{k}}{‖ {P}_{i} - {T}_{k} ‖ \cdot ‖ {n}_{k} ‖} ) , 0 \leq {β}_{k , i} \leq \frac{1}{2} {ϵ}_{m} ;$$

wherein, nₖ is the normal vector of the triangular mesh element; Tₖ is the centroid of the triangular mesh element; Pᵢ is a way point; β_{k,i} is the included angle between the connecting line that is between Pᵢ and the centroid Pᵢ of the triangular mesh element and the normal vector nₖ of the triangular mesh element; and ϵₘ is the maximum cone angle of the field of view of Pᵢ.
(2) A detection depth constraint of the visual sensor: the triangular mesh element k must be located within a depth range of the visual sensor, that is, a projection distance from the observation point Pᵢ to the centroid Tₖ on the normal vector of the triangular mesh element k needs to be within the depth range of the visual sensor. That is, a condition that needs to be met is as the following formula:

disₘᵢₙ≤(Pᵢ−Tₖ)·nₖ≤disₘₐₓ;
wherein, disₘᵢₙ represents a minimum visual depth of the visual sensor; and disₘₐₓ represents a maximum visual depth of the visual sensor.
(3) An occlusion-free constraint: there is no occlusion between the observation point Pᵢ and the centroid Tₖ.

To represent the triangular mesh element that the climbing robot may observe at the observation point Pᵢ, a concept of a visibility matrix is introduced. At the observation point Pᵢ, for all the triangular mesh elements T={T₁, T₂, . . . , Tₖ}, a binary variable

$${r}_{i}^{k}$$

is introduced to represent the visibility of a k^{th} triangular mesh element. If

$${r}_{i}^{k} = 1 ,$$

it is represented that at the observation point Pᵢ, the k^{th} triangular mesh element is visible, that is, meeting the detection inclination angle constraint of the visual sensor, the detection depth constraint of the visual sensor, and the occlusion-free constraint. On the contrary, the triangular mesh element is invisible. Therefore, introducing the visibility matrix represents that the visibility of all the triangular mesh elements T may be obtained at the observation point Pᵢ, that is:

$${s}_{i} = [ {r}_{i}^{1} , {r}_{i}^{2} , … , {r}_{i}^{k} ] .$$

Step 2: establishing a mathematical model for full coverage observation point optimization of the climbing robot, with the minimum number n of the observation points as an objective function and component (the steel structure) attachment and grid full coverage as constraints.

The objective function is represented as: min n.

The component attachment constraint is represented as:

gᵢ(v)=ƒᵢ(v)=0;
setting G(v)={g₁(v), g₂(v), . . . , gₘ(v)}, where gᵢ(v) represents that the climbing robot is located on an i^{th} curve, v represents spatial coordinates (x, y, z) of the climbing robot, a support on the surface of each climbable steel structure roof is abstracted into a curve, and lᵢ represents a spatial equation of the i^{th} curve; and ƒᵢ(v) represents a spatial distance between the climbing robot and the i^{th} curve, that is: ƒᵢ(v)=∥v−lᵢ∥=∥(x, y, z)−lᵢ∥.

The grid full coverage constraint is represented as:

$${\sum }_{i = 1}^{n} {r}_{i}^{j} \geq 1 ∀ j ∈ \{ 1 , 2 , … , k \} ;$$

setting an inspection path coverage matrix S_{n×k}:

$${S}_{n \times k} = [ \begin{matrix}{S}_{1} \\ {S}_{2} \\ ⋮ \\ {S}_{n}\end{matrix} ] = [ \begin{matrix}{r}_{1}^{1} & {r}_{1}^{2} & ⋯ & {r}_{1}^{k} \\ {r}_{2}^{1} & {r}_{2}^{2} & ⋱ & {r}_{2}^{k} \\ ⋮ & ⋮ & ⋱ & ⋮ \\ {r}_{n}^{1} & {r}_{n}^{2} & ⋯ & {r}_{n}^{k}\end{matrix} ] ,$$

wherein, k represents a number of the triangular mesh elements corresponding to the observation point Pᵢ, and n represents a number of the observation points; and for all the triangular mesh elements T={T₁, T₂, . . . , Tₖ}, k∈N₊, a binary variable

$${r}_{i}^{j}$$

is introduced to represent the visibility of the observation point Pᵢ to a j^{th} triangular mesh element. If

$${r}_{i}^{j} = 1 ,$$

it is represented that the j^{th} triangular mesh element is visible at the observation point Pᵢ. On the contrary, the triangular mesh element is invisible. Therefore, introducing the visibility matrix represents that the visibility of all the triangular mesh elements T may be obtained at the observation point Pᵢ, that is:

$${s}_{i} = [ {r}_{i}^{1} , {r}_{i}^{2} , … , {r}_{i}^{k} ] .$$

By setting the visual coverage constraint, it is represented that the climbing robot implements visual spatial coverage after passing through a series of observation points P={P₁, P₂, . . . , Pₙ}, n∈N₊. The visibility matrices of various observation points on the entire path form the inspection path coverage matrix. If the visual spatial full coverage needs to be implemented, each triangular mesh element at least needs to be detected once. Therefore, the visual spatial coverage constraint (the grid full coverage constraint) may be represented as:

$${\sum }_{i = 1}^{n} {r}_{i}^{j} \geq 1 ∀ j ∈ \{ 1 , 2 , … , k \} .$$

Step 3: proposing a large-scale parallel particle swarm algorithm based on a GPU (graphics processing unit), and solving the problem (the mathematical model for full coverage observation point optimization of the climbing robot), to obtain the plurality of (m) observation points V={v₁, v₂, . . . , vₘ}, thereby implementing visual full coverage with the minimum observation points; and after obtaining the plurality of observation points, studying an observation point connection criterion and forming the spatial observation map, thereby performing the edge weight assignment according to the path distance, the passage width, the obstacle density, and the like:

wᵢⱼ=α·dᵢⱼ+β·ƒᵢⱼ+γ·oᵢⱼ;
wherein, α, β, and γ represent weights of actual path distance, passage width, and obstacle density factors respectively, and values thereof are adjusted according to actual application requirements; wᵢⱼ is used for calculating a priority from the observation point Pᵢ to another observation point Pⱼ and is used in a Floyd-Warshall (Floyd) algorithm, to acquire an optimal path traversing all the observation points; dᵢⱼ represents the path distance, that is, a path distance from an i^{th} observation point Pᵢ to a j^{th} observation point Pⱼ; ƒᵢⱼ represents the passage width and refers to the width of the path or the difficulty degree of passing through the path; and oᵢⱼ represents the obstacle density, that is, an obstacle density on the path from the observation point Pᵢ to the observation point Pⱼ.

Step 4: based on this, modeling a visual full coverage problem by using an optimal Hamiltonian path, and constructing the TSP (traveling salesman problem) extended graph through the virtual node and the Floyd-Warshall algorithm.

Step 401: constructing an initial graph.

A complete graph (the spatial observation map) G is established initially, which includes m observation points, that is, the m observation points obtained through optimization in step 4, and a path distance adjacency matrix D of the observation points is constructed.

Inputting: a set of observation points V={v₁, v₂, . . . , vₘ} obtained in step 4, and the adjacency matrix D={wᵢⱼ}.

Outputting: the initial graph G=(V, E), where an edge set E is composed of paths between all the observation points.

Step 402: introducing the virtual node.

To facilitate the formation of the optimal Hamiltonian path, a virtual node v₀ is constructed to be used as a start point and an end point of the path, the virtual node is connected to all the observation points in the initial graph to generate an expanded observation point set V′, and the problem is converted into a closed-loop problem to facilitate the path planning.

Inputting: the initial graph G=(V, E) and the adjacency matrix D.

Outputting: an expanded graph G′=(V′, E′) and an expanded adjacency matrix D′.

Step 403: calculating a shortest path by using the Floyd-Warshall algorithm.

Each observation point is used as a node, the Floyd-Warshall algorithm is used to calculate a shortest path distance between all nodes, and G′ is converted into a complete graph.

Inputting: the expanded adjacency matrix D′.

Outputting: an updated shortest adjacency matrix Dₘᵢₙ.

Step 404: constructing the TSP extended graph.

Each observation point is used as a node, an edge weight value corresponding to each node adopts the shortest path distance in Dₘᵢₙ; and the virtual node v₀ is used as the start point and the end point, to ensure that the path is closed at the start and end points of the virtual node. In this way, the problem is converted into a TSP problem.

Inputting: the shortest path adjacency matrix Dₘᵢₙ, and the virtual node v₀.

Outputting: the TSP extended graph G_{TSP}.

Step 5: establishing an equivalence relation between a TSP path and a Hamiltonian path, effectively learning and extracting geometrical features of different scales of steel structures to improve a generalization capability by using a reinforcement learning policy network based on a graph neural network (GNN), and constructing a small data set to effectively initialize the policy network by using imitation learning, thereby efficiently solving the large-scale TSP problem and giving the full coverage optimal path planning for the steel structure roof.

The reinforcement learning policy network based on the graph neural network is an existing network.

For the reinforcement learning policy network based on the graph neural network, an input is the TSP extended graph (GTSP), and an output is the optimal Hamiltonian path, representing the observation point full coverage optimal path, that is, the optimal path of the climbing robot.

Step 6: for problems of reflection interference, signal occlusion, and unavailability of GPS (global positioning system) signals within the steel structure, establishing a multi-source information integrated positioning solution based on UWB (ultra-wideband) and IMU (inertial measurement unit) sensors, establishing a location probability (PI-LPM) model in combination with a path constraint condition that the climbing robot can only be located on the surface of a steel component, and calculating a constrained probability density map near the component by using a kernel probability density model.

Assuming that x is a possible position of the robot on a climbable path (the full coverage optimal path), and samples X={x₁, x₂, . . . , x_{N}} are positions of N independent and identically distributed path sampling points, where a path sampling point xᵢ is obtained by sampling after path planning, the probability of the robot appearing near the sampling point xᵢ can be represented by the following formula:

Pᵢ(x)=K_{H}(x−xᵢ);
wherein, K( ) is a kernel function; H is a bandwidth matrix, which may also be referred to as a window; and K_{H}( ) is a scaling kernel function.

A standard multivariate Gaussian kernel function with a dimension d is:

$${K}_{H} ( x ) = {( 2 π )}^{- \frac{d}{2}} {\vert H \vert}^{\frac{1}{2}} exp ( - \frac{1}{2} {x}^{T} {H}^{- 1} x ) .$$

The position of the climbing robot is composed of position information of three dimensions, taking d=3, which may be represented as:

$${P}_{i} ( x ) = {K}_{H} ( x - {x}_{i} ) = {( 2 π )}^{- 3 / 2} {\vert H \vert}^{- 1 / 2} \cdot exp [ - \frac{1}{2} {( x - {x}_{i} )}^{T} {H}^{- 1} ( x - {x}_{i} ) ] .$$

According to a kernel density estimation method, Gaussian kernel functions of the N independent and identically distributed sampling points are linearly superimposed and normalized, to obtain a probability density of the PI-LPM (path-induced location probability map) model under the three-dimensional Gaussian kernel density:

$$P ( x ) = \frac{1}{N} {\sum }_{i = 1}^{N} {( 2 π )}^{- 3 / 2} {\vert H \vert}^{- 1 / 2} \cdot exp [ - \frac{1}{2} {( x - {x}_{i} )}^{T} {H}^{- 1} ( x - {x}_{i} ) ] .$$

The present example provides an information fusion method for PL-PLM location probability and UWB/IMU integrated positioning based on square root unscented Kalman filter (SR-UKF), to implement high-precision spatial positioning of the robot that meets component path constraints, which specifically includes:

Step 601: acquiring positioning information of the UWB/IMU (observation data) and the observation point full coverage optimal path.

Step 602: a prediction stage.

A matrix constructed by using Sigma points is:

χₖ₋₁=[\hat{x}ₖ₋₁\hat{x}ₖ₋₁+\sqrt{(n+λ)}Sₖ\hat{x}ₖ₋₁−\sqrt{(n+λ)}Sₖ];
wherein, Sₖ represents a square root matrix of a state covariance matrix; n represents a number of dimensions of a state vector; λ represents an expansion parameter of UKF; χₖ₋₁ represents a Sigma point set at a moment k−1, a first point is a state estimation average value, and other points are generated through weighting of the square root of the covariance matrix; and \hat{x}ₖ₋₁ represents a state estimation average value at the moment k−1.

State equation processing is performed on the Sigma points generated in the above formula, and a state quantity and an error variance matrix at a moment k are predicted:

$$\{ \begin{matrix}{χ}_{i , k}^{*} - 1 = {A}_{k} - 1 {χ}_{i , k - 1} + {B}_{k - 1} {u}_{k - 1} \\ {\hat{x}}_{k} = {\sum }_{i = 0}^{2 n} {ω}_{i}^{m} {χ}_{i , k - 1}^{*} \\ {S}_{k}^{*} = qr \{ \sqrt{{ω}_{i}^{m}} ( {χ}_{i , k - 1}^{*} - {\hat{x}}_{k} ) \sqrt{{Q}_{k}} \} \\ {S}_{k} = cholupdate \{ {S}_{k}^{*} , ( {χ}_{0 , k - 1}^{*} - {\hat{x}}_{k} ) , {ω}_{0}^{c} \}\end{matrix} ;$$

wherein, a number of the sigma points in the Sigma point set is 2n+1; χ_{i,k-1} represents an actual value of an i^{th} sigma point at the moment k−1;

$${χ}_{i , k - 1}^{*}$$

represents a prediction value of the i^{th} sigma point at the moment k−1 after applying a state transition model; Aₖ₋₁ represents a state transition matrix and is used for mapping a state at the previous moment k−1 to the current moment k; Bₖ₋₁ represents a control input matrix and is used for mapping a control input to a state space; uₖ₋₁ represents a control input (the positioning information of the IMU, including acceleration, an angular velocity, and the like) at the moment k−1; \hat{x}ₖ represents a predicted state average value at the moment k and is obtained by taking a weighted sum of all the sigma points;

$${ω}_{i}^{m}$$

represents an average value weight of the i^{th} sigma point, and these weights are used for calculating the predicted state average value;

$${S}_{k}^{*}$$

represents a predicted error covariance matrix at the moment k and is obtained by calculating a covariance of the sigma point and a process noise covariance Qₖ;

$${ω}_{i}^{c}$$

represents a covariance weight of the i^{th} sigma point, and these weights are used for calculating the predicted error covariance matrix; Qₖ is a process noise covariance matrix and represents model uncertainty; Sₖ represents a final value of the predicted error covariance matrix at the moment k; and cholupdate is a function and is used for updating the covariance matrix Sₖ, to include a covariance between an initial sigma point and the predicted state average value.

Step 603: an updating stage.
a UWB data observation model:

y_{UWB}=h_{UWB}(xₖ₋₁)+v_{UWB};
wherein, y_{UWB} represents an observation value of the UWB, which is an absolute position acquired by the robot through the UWB; h_{UWB}(xₖ₋₁) represents an observation function of the UWB; and v_{UWB} represents observation noise of the UWB.
a PI-LPM data observation model:

y_{PI-LPM}=h_{PI-LPM}(xₖ₋₁)+v_{PI-LPM};
wherein, y_{PI-LPM} represents an observation value of the PI-LPM and represents a probability value corresponding to the position of the robot; h_{PI-LPM}(xₖ₋₁) represents an observation function of the PI-LPM, that is, P (x), which maps the position to the probability value on the path probability distribution; and v_{PI-LPM} represents observation noise of the PI-LPM.

Calculating:

$$\{ \begin{matrix}{y}_{k - 1} = [ \begin{matrix}{y}_{UWB} \\ {y}_{PI - LPM}\end{matrix} ] \\ {\hat{y}}_{k} = {\sum }_{i = 0}^{2 n} {ω}_{i}^{m} {y}_{k - 1}\end{matrix} ;$$

wherein, yₖ represents a joint observation value, including observation data of the UWB and the PI-LPM; and ŷₖ represents a predicted observation average value.

Calculating a variance matrix of an output variable at the moment k:

$${S}_{yy}^{*} = qr \{ \sqrt{{ω}_{i}^{c}} ( {y}_{k - 1} - {\hat{y}}_{k} ) \sqrt{{R}_{k}} \} ;$$

wherein,

$${S}_{yy}^{*}$$

is used for representing an intermediate calculation result of an observation variance matrix; qr represents a QR decomposition operation and is used for matrix decomposition; and Rₖ is an observation noise covariance matrix and represents a measurement error.

Calculating:

$${S}_{yy} = cholupdate \{ {S}_{yy}^{*} , ( {y}_{k - 1} - {\hat{y}}_{k} ) , {ω}_{0}^{c} \} ;$$

wherein, S_{yy} is an observation covariance matrix after being updated by using Cholesky (a square root method).

Calculating a covariance between a state quantity and an observation quantity at the moment k:

$${P}_{xy} = {\sum }_{i = 0}^{2 n} {{ω}_{i}^{c} [ {χ}_{i , k - 1}^{*} - {\hat{x}}_{k} ] [ {y}_{k - 1} - {\hat{y}}_{k} ]}^{T} ;$$

wherein, P_{xy} is a joint covariance matrix of the state quantity and the observation quantity; \hat{x}ₖ represents a state average value at a predicted moment; and ŷₖ represents a predicted observation average value.

Calculating a Kalman filter gain:

$${K}_{k} = \frac{( \frac{{P}_{xy}}{{S}_{yy}^{T}} )}{{S}_{yy}} ;$$

wherein, Kₖ is a Kalman gain matrix, is used for updating a state estimation, and represents a weight of the observation on the state estimation; P_{xy} represents the joint covariance matrix of the state quantity and the observation quantity and represents a correlation between the state quantity and the observation quantity; and S_{yy} is a covariance matrix of the observation quantity and represents uncertainty of the observation.

Updating the state quantity and the square root of the error variance matrix:

$$\{ \begin{matrix}{x}_{k} = {\hat{x}}_{k} + {K}_{k} ( {y}_{k - 1} - {\hat{y}}_{k} ) \\ {U}_{k} = {K}_{k} {S}_{yy} \\ {S}_{k} = cholupdate \{ {S}_{k} , {U}_{k} , - 1 \}\end{matrix} ;$$

wherein, Uₖ represents an intermediate value for updating a predicted error covariance matrix.

Step 604: judging whether a result (the position information included in xₖ) of fusion positioning of the IMU and the UWB is within a geometrical range of a certain component, and if a constraint condition of the geometrical range of the component is met, outputting a serial number of the component and a relative position of the robot relative to the component, to obtain a fusion positioning result of the component and the relative position where the robot is located; otherwise, returning positioning failure information, and prompting to recalibrate the sensor or increase positioning data sampling. For the relative position and the serial number of the component, the positioning result is matched with the steel structure to determine which component the robot is on and which position on the component the robot is at.

In the present example, for the requirements of visual detection of the steel structure roof, a field of vision model of a panoramic visual detection device is established, and a mathematical description of an effective sensing space of a fixed observation point is established.

In the present example, the mathematical model with the minimum number of the observation points as the objective and the component attachment and the grid full coverage as the constraints is established, thereby implementing the efficient visual full coverage of the steel structure roof.

In the present example, based on the optimal Hamiltonian path theory, and by combining the virtual node with the Floyd-Warshall algorithm, the TSP extended graph is constructed, and the equivalence relation between the TSP path and the Hamiltonian path is established, thereby providing the effective path planning solution for the visual full coverage problem.

In the present example, based on the IMU and UWB multi-source information integrated positioning solution, the PI-LPM location probability model is introduced, and the positioning information fusion is performed based on the SR-UKF, thereby accurately positioning the climbing robot.

In conclusion, in the present example, the full coverage path planning of the climbing inspection robot for the high-rise steel structure roof is implemented.

In one or more examples, a non-transitory computer-readable storage medium is provided, having a computer program stored thereon, where the program is executed by a processor, and the program, when executed by the processor, implements the steps in the above control method of a climbing inspection robot capable of self-adaptive obstacle crossing in multiple scenarios.

In one or more examples, a computer device is further provided, including a memory, a processor, and a computer program stored on the memory and executable on the processor, where when executing the program, the processor implements the steps in the above control method of a climbing inspection robot capable of self-adaptive obstacle crossing in multiple scenarios.

The foregoing descriptions are merely illustrative of the preferred examples of the present invention and are not intended to limit the present invention, and for those skilled in the art, the present invention may have various changes and modifications. Any modifications, equivalent replacements, and improvements made within the spirit and principle of the present invention shall fall within the scope of protection of the present invention.

1. A control method of a climbing inspection robot capable of self-adaptive obstacle crossing in multiple scenarios, wherein the climbing inspection robot capable of self-adaptive obstacle crossing in multiple scenarios comprises at least three moving mechanisms, and any two adjacent moving mechanisms are connected by an inter-module linkage rod; and a middle-segment portion of the inter-module linkage rod is provided with a multi-degree of freedom (DOF) active spherical servo joint;
each of the at least three-moving mechanisms at least comprises: a control portion, a support portion, a sensing portion, and a climbing portion; and the control portion is arranged in the support portion, and both the sensing portion and the climbing portion are communicatively connected to the control portion;
the climbing portion at least comprises a pair of side-arm linkage rods, which are symmetrically arranged on two sides of the support portion; and a tail end of each of the side-arm linkage rods is connected to a dynamic magnetic adhesion wheel through a wrist joint;
a self-adaptive passive wheel is mounted on a bottom of the support portion, and the self-adaptive passive wheel and dynamic magnetic adhesion wheels disposed at the two sides of the support portion form a three-point clamping structure; and
the sensing portion at least comprises an obstacle sensing element and a distance measurement element, which are used for sensing obstacle information and detecting an obstacle distance respectively, and transmitting the obstacle information and the obstacle distance to the control portion;
wherein, the control method of the climbing inspection robot capable of self-adaptive obstacle crossing in multiple scenarios, comprising:
determining a next to-be-executed obstacle avoidance operation according to currently sensed obstacle information and a detected obstacle distance; and
controlling an attitude of the climbing inspection robot based on a current attitude and the next to-be-executed obstacle avoidance operation of the climbing inspection robot, to enable the climbing inspection robot to avoid an obstacle successfully;
wherein, a process of the obstacle avoidance operation comprises:
controlling the multi-DOF active spherical servo joint to drive the inter-module linkage rod and a head moving mechanism to move, to enable the head moving mechanism to lift, simultaneously controlling the dynamic magnetic adhesion wheels of the head moving mechanism to lift to avoid the obstacle, controlling the climbing inspection robot to move forward, to enable the head moving mechanism to cross the obstacle, and controlling a middle moving mechanism to be ready to lift;
controlling the dynamic magnetic adhesion wheels of the head moving mechanism to return to an original state to attach and adhere to a steel structure, controlling the multi-DOF active spherical servo joint to drive the inter-module linkage rod and the head moving mechanism to move, to enable the head moving mechanism to perform three-point clamping, simultaneously controlling the middle moving mechanism to lift, and controlling the dynamic magnetic adhesion wheels of the middle moving mechanism to lift;
controlling the climbing inspection robot to move forward, to enable the middle moving mechanism to cross the obstacle, and controlling a tail moving mechanism to be ready to lift; then, controlling the middle moving mechanism to return to an original traveling state and the tail moving mechanism to lift to cross the obstacle; and finally, controlling the tail moving mechanism to return to the original traveling state; and
before controlling the attitude of the climbing inspection robot, determining an attitude adjustment action by using a deep reinforcement learning method based on the currently sensed obstacle information and the obstacle distance, wherein a formula of a reward function of the deep reinforcement learning method is:
$$R = {α}_{1} \frac{A}{{A}_{m ax}} + {α}_{2} {e}^{- σ ( {\sum }_{j = 1}^{k} \vert {d}_{j} - {d}_{target} \vert )} - {α}_{3} ( \vert ϕ - {ϕ}_{stable} \vert + \vert θ - {θ}_{stable} \vert ) - {α}_{4} \frac{P}{{P}_{m ax}} ;$$
wherein, A is a normalized value of a current contact area of the dynamic magnetic adhesion wheels with a value range of [0,1] and is used for measuring an attachment state between the dynamic magnetic adhesion wheels and the steel structure; Aₘₐₓ is a theoretical maximum contact area and is used for normalization processing; weight coefficients α₁, α₂, α₃, α₄ are weights for balancing contact area optimization, attitude stability, distance adaptability, and energy consumption; dⱼ is a real-time distance measurement value of a j^{th} distance measurement element, and k represents a number of the distance measurement elements; d_{target} is an ideal distance measurement value, and σ is a smoothing parameter of a distance measurement deviation; attitude angles φ, θ represent a pitch angle and a roll angle of the current attitude; φ_{stable} and θ_{stable} are a pitch angle and a roll angle that correspond to an ideal stable attitude respectively; and P is current power consumption, and Pₘₐₓ is a maximum power consumption threshold, which are used for normalizing power consumption data.

2. The control method of the climbing inspection robot capable of self-adaptive obstacle crossing in multiple scenarios according to claim 1, wherein an adjustment angle of the wrist joint is calculated according to a distance between a wheel face of the dynamic magnetic adhesion wheel and a surface of the steel structure, to enable the dynamic magnetic adhesion wheel to actively attach to the steel structure; and a calculation formula of the adjustment angle θ_{wrist} of the wrist joint is:
$${θ}_{wrist} = arccos ( \frac{h - s}{L} ) ;$$
wherein, s is the distance between the wheel face of the dynamic magnetic adhesion wheel and the surface of the steel structure; h is a vertical distance between an axis of the wrist joint and the surface of the steel structure; and L is a length between the wrist joint and the wheel face of the dynamic magnetic adhesion wheel.

3. The control method of the climbing inspection robot capable of self-adaptive obstacle crossing in multiple scenarios according to claim 1, wherein the self-adaptive passive wheel comprises a self-adaptive spring, a wheel carrier, a bearing, two magnetic adhesion passive wheels, and a connecting plate; one end of the self-adaptive spring is connected to the connecting plate, and the other end is connected to a top end of the wheel carrier; the connecting plate is fixed at the bottom of the support portion; and the bearing is fixed at a tail end of the wheel carrier, and the magnetic adhesion passive wheels are mounted at two ends of the bearing.

4. The control method of the climbing inspection robot capable of self-adaptive obstacle crossing in multiple scenarios according to claim 1, wherein the dynamic magnetic adhesion wheel comprises a flexible wheel face, and Halbach array electromagnets are wrapped in the flexible wheel face; coils are wound outside the Halbach array electromagnets, and the coils are connected to a power supply module; and the Halbach array electromagnets are used for generating magnetic field intensity when the coils are powered on, to enable the dynamic magnetic adhesion wheel to adhere to the steel structure.

5. The control method of the climbing inspection robot capable of self-adaptive obstacle crossing in multiple scenarios according to claim 1, wherein an adhesion force of the dynamic magnetic adhesion wheel is determined by the magnetic field intensity, and the magnetic field intensity is controlled by an output current of the power supply module; the output current of the power supply module is controlled by dynamically adjusting a duty cycle of a pulse-width modulation (PWM) signal; and the duty cycle of the PWM signal is obtained through dynamic adjustment by using a fuzzy logic control algorithm according to a current adhesion force, a set target adhesion force, and an external load change.

6. The control method of the climbing inspection robot capable of self-adaptive obstacle crossing in multiple scenarios according to claim 5, wherein formulas of dynamically adjusting the duty cycle D of the PWM signal by using the fuzzy logic control algorithm are:
$$D = \frac{{\int }_{z} z \cdot {μ}_{out} ( z ) dz}{{\int }_{z} {μ}_{out} ( z ) dz} ;$$
$${μ}_{out} ( z ) = max ( {μ}_{R 1} ( z ) , {μ}_{R 2} ( z ) , … , {μ}_{Rn} ( z ) ) ;$$
$${μ}_{Ri} ( z ) = min ( {μ}_{A} ( x ) , {μ}_{B} ( y ) ) ; i = 1 , 2 , … , n ;$$
$${μ}_{A} ( x ) = \{ \begin{matrix}1 , & x \leq a \\ \frac{b - x}{b - a} , & a < x \leq b \\ 0 , & x > b\end{matrix} ;$$
$${μ}_{B} ( y ) = \{ \begin{matrix}\frac{y - c}{d - c} , & c \leq y < d \\ 1 , & y \geq d\end{matrix} ;$$
wherein, z represents a possible value range of an output variable, and μₒᵤₜ(z) represents a multi-rule fuzzy inference membership function; x and y are the adhesion force and the load change respectively; μ_{Ri}(z) represents a fuzzy inference membership function of the climbing inspection robot under an i^{th} attitude; n represents a number of attitude types of the climbing inspection robot; μ_{A}(x) and μ_{B}(y) represent membership functions of the adhesion force and the load change respectively; and a, b, c, d are corresponding variable parameters of the climbing inspection robot under different attitudes.

7. The control method of the climbing inspection robot capable of self-adaptive obstacle crossing in multiple scenarios according to claim 1, wherein the multi-DOF active spherical servo joint comprises a flexible housing, two active joint servos, and two rigid joint connecting rods; all the active joint servos are disposed in the flexible housing, the active joint servos are in one-to-one correspondence with the rigid joint connecting rods, and the active joint servos and the rigid joint connecting rods that correspond to each other are coupled and hinged; and one end of each of the rigid joint connecting rods further extends out of the flexible housing and is connected to the inter-module linkage rod.

8. The control method of the climbing inspection robot capable of self-adaptive obstacle crossing in multiple scenarios according to claim 1, wherein the obstacle sensing element is fixed at a set position on the support portion of each of the head moving mechanism and the tail moving mechanism of the climbing inspection robot capable of self-adaptive obstacle crossing in multiple scenarios; and the distance measurement element is mounted on each of the dynamic magnetic adhesion wheels.

9. The control method of the climbing inspection robot capable of self-adaptive obstacle crossing in multiple scenarios according to claim 1, wherein the control portion at least comprises one or more processors, a memory, and a computer program stored on the memory and executable on the one or more processors, and when the one or more processors execute the computer program, the control portion executes the following path planning steps:
acquiring a steel structure model, dividing a surface of a steel structure roof into a plurality of triangular mesh elements, and determining visibility of each observation point to all the triangular mesh elements;
based on the visibility of each observation point to all the triangular mesh elements, by using a minimum number of the observation points as an objective, and under a steel structure attachment constraint and a grid full coverage constraint, after a plurality of observation points are obtained through optimization, performing edge weight assignment according to a path distance, a passage width, and an obstacle density, to form a spatial observation map; based on the spatial observation map, introducing a Floyd-Warshall algorithm through a virtual node, to obtain a shortest adjacency matrix; and by using each observation point in the spatial observation map as a node, using a shortest path distance in the shortest adjacency matrix as an edge weight value, and using the virtual node as a start point and an end point, constructing a traveling salesman problem (TSP) extended graph;
inputting the constructed traveling salesman problem (TSP) extended graph into a reinforcement learning policy network that is based on a graph neural network, and outputting an action instruction of a related action; and
controlling the climbing portion to act according to the output action instruction, to enable the climbing robot to climb and move according to an output optimal path.

10. The control method of the climbing inspection robot capable of self-adaptive obstacle crossing in multiple scenarios according to claim 9, wherein the visibility of each observation point to all the triangular mesh elements is determined through the following constraints:
a detection inclination angle constraint of a visual sensor:
$${β}_{k , i} = arccos ( \frac{( {P}_{i} - {T}_{k} ) \cdot {n}_{k}}{‖ {P}_{i} - {T}_{k} ‖ \cdot ‖ {n}_{k} ‖} ) ;$$
wherein, nₖ is a normal vector of a k^{th} triangular mesh element, Tₖ is a centroid of the k^{th} triangular mesh element, Pᵢ is an i^{th} observation point, and β_{k,i} is an included angle formed between a connecting line that is between Pᵢ and Tₖ and nₖ;
a detection depth constraint of the visual sensor:
disₘᵢₙ≤(Pᵢ−Tₖ)·nₖ≤disₘₐₓ;
wherein, disₘᵢₙ represents a minimum visual depth of the visual sensor, and disₘₐₓ represents a maximum visual depth of the visual sensor; and
an occlusion-free constraint:
no occlusion between the observation point Pᵢ and the centroid Tₖ of the triangular mesh element.

11. The control method of the climbing inspection robot capable of self-adaptive obstacle crossing in multiple scenarios according to claim 9, wherein the steel structure attachment constraint is:
gᵢ(v)=ƒᵢ(v)=0;
wherein, a support on the surface of each climbable steel structure roof is abstracted into a curve, and lᵢ represents a spatial equation of an i^{th} curve; v represents spatial coordinates of the climbing robot; gᵢ(v) represents that the climbing robot is located on the i^{th} curve; and ƒᵢ(v) represents a spatial distance between the climbing robot and the i^{th} curve, that is: ƒᵢ(v)=∥v−lᵢ∥.

12. The control method of the climbing inspection robot capable of self-adaptive obstacle crossing in multiple scenarios according to claim 9, wherein the grid full coverage constraint is:
$${\sum }_{i = 1}^{n} {r}_{i}^{j} \geq 1 ∀ j ∈ \{ 1 , 2 , … , k \} ;$$
wherein, k represents a number of the triangular mesh elements, and n represents a number of the observation points; and a binary variable
$${r}_{i}^{j}$$
represents visibility or an observation point Pᵢ to a j^{th} triangular mesh element, and if
$${r}_{i}^{j} = 1 ,$$
it is represented that the j^{th} triangular mesh element is visible at the observation point Pᵢ.

13. The control method of the climbing inspection robot capable of self-adaptive obstacle crossing in multiple scenarios according to claim 9, wherein the edge weight assignment is represented as:
wᵢⱼ=α·dᵢⱼ+β·ƒᵢⱼ+γ·oᵢⱼ;
wherein, α, β, and γ are all weights; wᵢⱼ is a priority from an i^{th} observation point Pᵢ to a j^{th} observation point Pᵢ; dᵢⱼ represents a path distance from the i^{th} observation point Pᵢ to the j^{th} observation point Pⱼ; ƒᵢⱼ represents a passage width of a path from the i^{th} observation point Pᵢ to the j^{th} observation point Pⱼ; and oᵢⱼ represents an obstacle density on the path from the i^{th} observation point Pᵢ to the j^{th} observation point Pᵢ.

14. The control method of the climbing inspection robot capable of self-adaptive obstacle crossing in multiple scenarios according to claim 9, further comprising: acquiring positioning information of ultra-wideband and an inertial measurement unit, to obtain positioning of the climbing robot in combination with the optimal path of the climbing robot through square root unscented Kalman filter.

15-16. (canceled)

17. The control method of the climbing inspection robot capable of self-adaptive obstacle crossing in multiple scenarios according to claim 4, wherein an adhesion force of the dynamic magnetic adhesion wheel is determined by the magnetic field intensity, and the magnetic field intensity is controlled by an output current of the power supply module; the output current of the power supply module is controlled by dynamically adjusting a duty cycle of a PWM signal; and the duty cycle of the PWM signal is obtained through dynamic adjustment by using a fuzzy logic control algorithm according to a current adhesion force, a set target adhesion force, and an external load change.
